(19) United States
(12) Patent Application Publication
(10) Pub. No.: US 2013/0298459 A1
(43) Pub. Date: Nov. 14, 2013

(54) SYSTEM AND METHOD FOR AUTOMATING CROP ASSOCIATED SELECTION OF SPECTRAL AGRICULTURAL LIGHTING PROGRAMS

(71) Applicant: Jeff Bucove, Victoria (CA)

(72) Inventor: Jeff Bucove, Victoria (CA)

(21) Appl. No.: 13/820,921

(22) PCT Filed: Sep. 6, 2011
(86) PCT No.: PCT/CA2011/050538

§ 371 Date: Mar. 5, 2013

Related U.S. Application Data
(60) Provisional application No. 61/380,292, filed on Sep. 6, 2010.

(51) Int. Cl. A01G 7/04; A01G 1/00; H05B 37/02

(52) U.S. Cl. CPC A01G 7/045; H05B 37/02; A01G 1/001
USPC 47/58.1 LS; 315/153

(57) ABSTRACT

The system of the indention is applied to sunless enclosed spaces suitable for agricultural use. A growing zone is seeded with a particular crop variety. The crop growth is optimized by receipt of a specific light emissions. A light emitting computer comprising an array of light emitting devices, a microprocessor, a radio frequency receiver and a storage device is disposed optimally over the growing zone to bath the zone uniformly in the specific light emission for optimal growth. A radio frequency identification tag is placed within the growing zone to electrically define the growth zone for the light emitting computer. The RFID tags emit a crop variety specific radio frequency that is received by the radio frequency receiver. The appropriate light emission profile related to the radio frequency is retrieved from a digital look-up table. The emitting computer then emits the light emission profile.

### TECHNICAL FIELD

This invention relates to the application of spectrum controlled artificial light to promote the growth of plants and specifically to a system for automating the crop associated selection of spectrally controlled agricultural lighting programs.

### BACKGROUND ART

In the course of my research on the manipulation of plant metabolisms through the application of light with a controlled variety of wavelengths and photoperiod power modulations, I have discovered overall harvest quality to be greatly enhanced through the use of electromagnetic energy stimulation programs specifically designed for particular plants, and that these programmed stimulations may additionally be altered within daily cycles and across the stages of life seasons to further optimize crop productivity.

### TECHNICAL PROBLEM

### Technical Solution

My invention is a system for management of and access to computer programs for controlling emissions of lights having a variety of wavelengths and photoperiod power modulations with the intent of optimizing commercial enclosed environment plant production. I have reasoned that large scale installations incorporating large numbers of computerized lighting systems emitting various controlled lighting spectrum for a great variety of crops would greatly benefit from the use of a system for automating the association between crops, lights, and lighting programs.

I propose the incorporation of ‘Radio Frequency Identification’ or ‘RFID’ technologies within the computerized agricultural lighting system for the purpose of physically locating crops with relation to the artificial lighting systems promoting crop growth. Further, the system includes software procedures to upload into the computer memory of the proximately located spectral agricultural lights those specifically associated computer programs which are then to provide the RFID tag identified crop with the intended spectral modulation of electromagnetic emissions thus promoting an intended growth pattern in the RFID associated crop.

The invention uses of RFID tags associated with the crop type. These associated RFID tags are then to be placed within and/or around the area planted with the associated crop type. The RFID tags may be packaged with seed of the associated crop type. The RFID tags may be scattered among seed of the associated crop type.

The invention uses a look-up table to associate a specific desired spectral modulation program to a specific crop type. The look-up table will designate a spectral modulated lighting program to be associated with specific crop as identified by the associated RFID. A computerized agricultural light will chose a spectral modulation lighting program to upload through the look-up table by radiometric correlation with RFID tags placed proximate to the crop at the time of planting. RFID tags will be electronically located by the computerized agricultural lights, thus providing the information required for proximate computerized agricultural lights to choose which specific crop lighting programs to be loaded and initiated.

RFID tags which are correlated within the lookup table will indicate which program the proximate computerized agricultural light is to upload and execute for the intended crop.

When new spectral programs are created to alter or manipulate the outcome of a given crop a new RFID tag designation will be added to the loop-up table.

Within a large commercial agricultural facility utilizing programmable agricultural spectral lighting technology, the use of this system allows any new crop to be planted anywhere within the facility as space becomes available. The requisite RFID tags will then be placed within an area which designates the area the crop is planted within, and these RFID tags will then signal the computerized agricultural lighting system within RFID reader range the area to be illuminated for the new crop.

Computerized agricultural lights reading RFID tags will map the area to be illuminated, and use the RFID tags to identify the specific spectral modulation lighting program through accessing the associated reference in the lighting program look-up table.

The computerized agricultural light will thus automatically locate the spectral agricultural lighting program in the lookup table and upload that program into runtime computer memory, then operate and apply the spectral agricultural lighting program from the lookup table to the physical area containing the identified crop to be so specifically illuminated, and initiate a synchronization of the spectral lighting plant manipulation program with the biological life cycle of the target crop as designated at the time of planting.

The Look-Up table can be in memory on board the computerized agricultural light, in the memory of a designated supervisor computerized agricultural light for the local computerized agricultural light group, or in a server at the local agricultural facility, or at a remote secured facility for proprietary research, or a remote public facility of open source research.

### Advantageous Effects

### DESCRIPTION OF DRAWINGS

FIG. 1 is a drawing of an agricultural plot using the invention.

FIG. 2 is a drawing of one embodiment at the invention in use over an agricultural plot.

FIG. 3 is a model of a look-up table of the invention.

### BEST MODE

My invention is a system and method allowing an area to be designated for the purpose of illumination with crop specific light. The system for automating crop associated selection of spectral agricultural light programs comprises a sunless enclosed space suitable for agricultural use and comprising an at least first growing zone seeded with a specific crop variety. The specific crop variety has a photosensitive biochemical activity that is optimized by receipt of a specific light emission. The light emitting computer comprises an array of light emitting devices, a micro-processor, a radio frequency receiver and a storage device disposed optimally over the at least first growing zone so that the at least first growing zones is bathed uniformly in the specific light emission. The system also includes a radio frequency identification tag placed at each corner of the at least first growing zone for emitting a crop variety specific radio frequency for receipt by the radio frequency receiver. The RFIDs define the area to be irradiated with the light emission for the light emitting computer. The RFIDs for a specific growing zone all emit the same frequency. A light emission profile is emitted by the light emitting computer for the crop variety specific radio frequency for optimizing the crop variety growth.

The light emission profile is retrievably stored in a digital look-up table within the storage device. The digital look-up table stores the light emission profile for a plurality of crop varieties. The light emission profile includes at least emission power, emission color and emission duration. The storage device is in remote communication with the light emitting computer. The look-up table is remotely programmable by wireless and wired means.

In one embodiment of the system a package of seeds for the specific crop variety includes the RFIDs emitting a crop variety specific radio frequency. The package includes data sufficient for programming the look-up table with the light emission profile for the crop variety.

In one embodiment of the invention the sunless enclosed space comprises a plurality of growing zones. At least one light emitting computer is optimally disposed over each of the plurality of growing zones. The growing zones are seeded each with a different plant and include RFIDs emitting a frequency specific to each of the different plants. The least one light emitting computer is connected to a look-up table containing a unique light emission profile for each different plant that is associated with the RFID frequency. The RFID frequency triggers the at least one light emitting computer to emit the unique emission profile.

One another embodiment of the system the at least one light emitting computer comprises a single light emitting computer disposed over a first growing zone on conveying means for conveying the single light emitting computer from said first growing zone to an adjacent second growing zone.

The method of using the system includes the following steps: selecting a sunless enclosed space suitable for agricultural use and comprising an at least first growing zone; Seeding the at least first growing zone with a specific crop variety having a photosensitive biochemical activity that is optimized by receipt of a specific light emission; Disposing a light emitting computer comprising an array of light emitting devices, a micro-processor, a radio frequency receiver and a storage device optimally over the at least first growing zone so that the at least first growing zones is bathed uniformly in a specific light emission profile; Placing an appropriate number of radio frequency identification tags within the at least first growing zone for emitting a crop variety specific radio frequency for receipt by the radio frequency receiver so that the light emitting computer knows the boundaries of the light emission profile; and, Emitting uniformly the light emission profile emitted from the light emitting computer for the crop variety specific radio frequency for optimizing the crop variety growth.

Further steps include: retrievably storing a digital look-up table within the storage device; and, recording the light emission profile for a plurality of crop varieties within the digital look-up table, wherein the light emission profile includes at least emission power, emission color and emission duration.

Referring to FIG. 1 there is illustrated a plan view of a plot of agricultural land 10 sown in a grid pattern with four different types of plants: A, B, C and D. Within each of the plots is a set of four RFID tags identified as 12, 14, 16 and 18. The RFID tags electronically define the growth zone for the light emitting computer as described below.

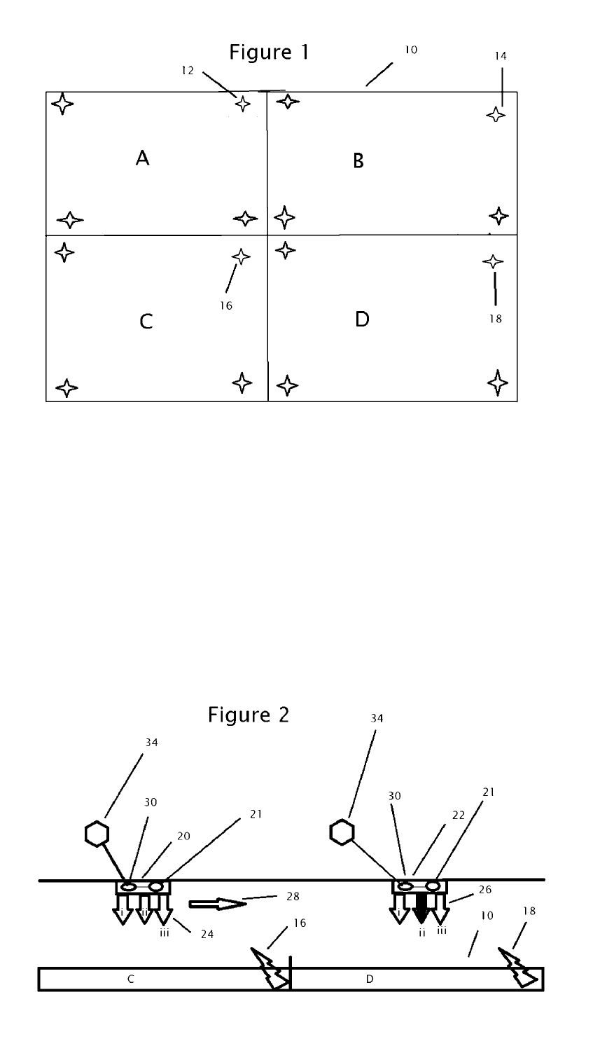

Referring to FIG. 2 there is shown an elevation view of the plot 10, sections C and D. RFID emitter sets 16 and 18 are installed in each plot and emit specific frequencies. The RFID emitter sets are placed in each plot at the time of planting. The RFID emitter sets 16 and 18 may be included with the seed package and pre-programmed to emit a specific first and second respective frequencies. The specific frequency is received by a receiver 21 installed on an array 20 and 22 of light emitting diodes or lamps (LEDs). The array of LEDs are disposed a suitable distance above the plots, that is, array 20 is disposed over plot C and array 22 is disposed over plot D. In an alternative configuration, a single array of emitting lamps 22 may be moved on a conveyor from plot to plot as designated by arrow 28. As the conveyor moves the array from plot C to plot D, the RFID tag set 18 emits a specific signal which in turn instructs the array to emit a specific pattern of light energy, at specific frequencies and power levels for a specific period of time. As shown in FIG. 2, array 20 may emit frequencies i, ii and iii whereas array 22 may emit frequencies i and iii, with emitter ii being off-black shade). The arrays are designed to be able to emit a single or a combination of light frequencies at specified power levels for specified periods of time. The light energy emitted is photo-manipulative, that is, designed to enhance the growth and health of the specific plant type.

Each of the arrays is controlled by an on-board micro-processor 30 connected to receiver 21. The signal frequency of the RFID emission is unique to a specific type of plant. The frequency is received by the microprocessor and converted into a digital signal unique to the plant being propagated. Each micro-processor is connected to a database 34 which contains a digitized look-up table.

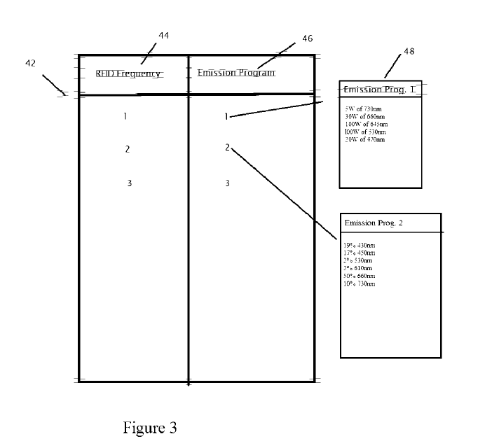

Referring to FIG. 3, there is shown a model of a look-up table 40. Each RFID frequency 42 is associated with a particular emission profile 44. For example, RFID set # 1 emits a frequency ?(1). RFID set #2 emits a frequency ?(2) and so on. Each of the frequencies is received by the received on the LED array and processed by the micro-processor into a digital signal that is unique to a light emission profile for the plant being propagated. As shown in FIG. 3, the first emission profile may comprise the following frequencies at the specified powers:

5 W of 730 nm

30 W of 660 nm

100 W of 645 nm

100 W of 530 nm

20 W of 470 nm

Alternatively, the program may specify a percentage of the array to emit specific frequencies as follows:

19% 430 nm

17% 450 nm

2% 530 nm

2% 610 nm

50% 660 nm

10% 730 nm

The array of LEDs is supplied by a constant power and programmable for various light on/off cycles such as 6/18, 12/12 and 18/6. There may also be an afterglow of 730 nm for about one hour right after the lights are turned off for each cycle.

In another embodiment of the invention an array of light sources is used comprising emissions in the range of 360 nm to 410 nm, 450 nm to 470 nm, 520 to 530 nm, 590 nm to 615 nm, 640 nm to 670 nm, and 720 nm to 890 nm with each wavelength operated using a dedicated controller. The micro-processor is then used to adjust the quality of the light emitted as the exposed plant matures. Since the light sources are placed on a large sized array, for example 40 cm by 40 cm, it is necessary to ensure that the exposed plant receives the appropriate amount of energy at the proper wavelength. To this end, the light sources may be equipped with holographic thin film. Fresnel lenses refract light to the plant. The closer the emitters are to the plant the greater the angle will have to be. In one embodiment of the invention emitters with holographic thin film Fresnel lenses creating a radiating arc in the range of 140 degrees are used.

Hence, in addition to frequencies and powers, the look-up table may contain other data used to configure the LED emitters for a specific plant such as length of time on and off. The arrays are large enough to provide a uniform bath of light over the crop area.

In one embodiment of the invention, the look-up tables are programmed and remotely stored and accessible by the micro-processor by wireless or hard-wired means.

Although the description above contains many specificities, these should not be construed as limiting the scope of the embodiments of the invention but as merely providing illustrations of some of the several embodiments. For example, the electromagnetic light energy emitter can comprise an array LEDs or a suitable lamp.

Thus the scope of the embodiments should be determined by the appended claims and their legal equivalents rather than by the examples given.

### Mode for Invention

### INDUSTRIAL APPLICABILITY

Sequence List Text

1. A system for automating crop associated selection of spectral agricultural light programs comprising:
a. A sunless enclosed space suitable for agricultural use and comprising an at least first graving zone seeded with a specific crop variety and wherein said specific crop variety has a photosensitive biochemical activity that is optimized by receipt of a specific; fight emissions;
b. A light emitting computer comprising an array of light emitting devices, a microprocessor, a radio frequency receiver and a storage device disposed optimally ever said at least first growing zone so that the at least first growing zones is bathed uniformly in said specific light emission;
c. An appropriate number of radio frequency identification tags placed within the at least first growing zone for emitting a crop variety specific radio frequency for receipt by said radio frequency receiver wherein said radio frequency identification tags electronically define the growing zone for the light emitting computer; and,
A light emission profile emitted by said light emitting computer for said crop variety specific radio frequency for optimizing the crop variety growth.

2. The system of claim 1 wherein said right emission profile is retrievably stored in a digital look-up table within said storage device.

3. The system of claim 2 wherein said digital look-up table stores the light emission profile for a plurality of crop varieties.

4. The system of claim 3 wherein the right emission profile includes at least emission power, emission color and emission duration.

5. The system of claim 4 wherein the storage device is in remote communication with the light emitting computer.

6. The system of claim 5 wherein the look-up table is remotely programmable by wireless and wired means.

7. The system of claim 6 wherein a package of seeds for the specific crop variety includes an RFID set emitting a crop variety specific radio frequency.

8. The system of claim 7 wherein said package includes data sufficient for programming the look-up table with the light emission profile for the trap variety.

9. The system of claim & wherein said sunless enclosed space comprises a plurality of growing zones.

10. The system of claim 9 wherein at least one right emitting computer is optimally disposed overreach of said plurality of growing zones.

11. The system of claim 10 wherein each of the plurality of growing zones is seeded with a different plant and includes a RFID set emitting a frequency specific to each of said different plant.

12. The system of claim 11 wherein said at least one light emitting computer is connected to a look-up table containing a unique light emission profile, for each different plant that is associated with said RFID frequency.

13. The system of claim 12 wherein the RFID frequency triggers the at least one-fight emitting computer to emit said unique emission profile.

14. The system of claim 13 wherein the at least one light emitting computer comprises a single light emitting computer disposed over a first growing zone on conveying means for conveying said single fight emitting computer from said first growing zone to a second growing zone.

15. A method for automating crop associated selection of spectral agricultural light programs comprising: Selecting a sunless enclosed space suitable for agricultural use and comprising an at least first growing zone; Seeding said at least first growing zone with a specific crop variety having a photosensitive biochemical activity that is optimized by receipt of a specific light emission; Disposing a light emitting computer comprising an array of light emitting devices, a micro-processor, a radio frequency receiver and a storage device optimally over the at least first growing zone so that the at least first growing zones is bathed uniformly in a specific light emission profile; Placing an appropriate number of radio frequency identification tags within the at least first growing zone for emitting a crop variety specific radio frequency for receipt by said radio frequency receiver, and, Emitting uniformly said light emission profile emitted from said light emitting computer for said crop variety specific radio frequency for optimizing the crop variety growth.

16. The method of claim 15 further comprising the step of retrievably storing a digital look-up table-within said storage device.

17. The method of claim 16 further comprising the step of recording the light emission profile for a plurality of crop varieties within said digital look-up table, wherein the light emission profile includes at least emission power, emission color and emission duration.
